(19) United States
(12) Patent Application Publication
(10) Pub. No.: US 2003/0186582 A1
(43) Pub. Date: Oct. 2, 2003

(54) Worksurface power module with built in USB hub

(76) Inventors: Gregg E. Laukhuf, Bryan, OH (US); Mark E. Ramsey, Fort Wayne, IN (US)

Correspondence Address: Todd T. Taylor, TAYLOR & AUST, P.C., 142 S. Main St., P.O. Box 560, Avilla, IN, 46710, US

(21) Appl. No.: 10/397,807

(22) Filed: Mar. 26, 2003

Related U.S. Application Data
(60) Provisional application No. 60/367,999, filed on Mar. 27, 2002.

(51) Int. Cl. H01R 13/60

(52) U.S. Cl. 439/535

(57) ABSTRACT

A power and communications assembly including a housing removably mountable to a worksurface, at least one electrical power receptacle at least partially contained in the housing and an electronic circuit configured to split one bi-directional signal into a plurality of additional bi-directional signals, the electronic circuit substantially within the housing.

### CROSS REFERENCE TO RELATED APPLICATIONS

This is a non-provisional application based upon U.S. provisional patent application serial No. 60/367,999, entitled “WORKSURFACE POWER MODULE WITH BUILT IN USB HUB”, filed Mar. 27, 2002.

### BACKGROUND OF THE INVENTION

1. Field of the Invention

The present invention relates to a power module mountable on a worksurface and more particularly, to a power module with communications ports mountable to a worksurface.

2. Description of the Related Art

Personal computers have been developed for many applications in many fields, such as medical care, business, education and industry. Due to the diverse applications, there are many peripheral devices, which are developed to cooperate with the personal computer to achieve particular functions. Some of the peripheral devices are connected with the personal computer by way of cables. Some connections utilize Universal Serial Bus (USB) cables, which are becoming quite popular.

The USB is a standard peripheral interface for attaching personal computers to a wide variety of peripheral devices including such things as keyboards, mice, scanners, printers, game controllers, modems and other peripherals. The USB allows up to 128 devices to be interconnected. When a USB device is plugged in, the device is automatically detected and the software to drive it is automatically configured. The USB provides a fast, bidirectional, low cost, dynamically attachable serial interface structure that is consistent with the requirements of the personal computer platform.

All USB devices connect to the USB through ports on specialized USB devices referred to as hubs. Hubs are wiring concentrators having attachment points referred to as ports. Each hub converts a single attachment port into multiple ports. This architecture supports concatenation of multiple hubs.

The USB topology is such that a USB connects USB devices with a USB host in a tiered star topology. A hub is at the center of each star and provides a point-to-point connection between the host and a hub or a peripheral function, or a hub connected to another hub or peripheral function. In the USB topology, there is only one host. A root hub is integrated within the host system to provide one or more attachment points. Additional attachment points to the USB are provided by hubs. Each hub may be connected to additional hubs and the functions which provide capabilities to the system, such as an ISDN connection, a digital joystick or speakers.

Power strips came into popular use along with the personal computer. Power strips typically have multiple power outlets and a switch to turn at least a portion of the electrical receptacles on and off.

What is needed in the art is a device for providing power and communication receptacles in an easily relocatable and attachable configuration.

### SUMMARY OF THE INVENTION

The present invention provides a portable power module with a built-in communication port.

The invention comprises, in one form thereof, a power and communications assembly including a housing removably mountable to a worksurface, at least one electrical power receptacle at least partially contained in the housing and an electronic circuit configured to split one bi-directional signal into a plurality of additional bi-directional signals, the electronic circuit substantially within the housing.

An advantage of the present invention is that it provides convenient USB connection ports.

Another advantage of the present invention is that it makes USB connection points easily accessible by placing them in a location on a worksurface rather than behind a CPU.

Yet another advantage of the present invention is that electrical power and USB connections are available in the same device.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of an embodiment of a power module with a built-in USB hub mounted on a work center according to one form of the invention;

FIG. 2 is a perspective exploded view of the power module with USB hub of FIG. 1; and

FIG. 3 is a partial cross-section view of the power module with USB hub of FIGS. 1 and 2 mounted to a worksurface.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

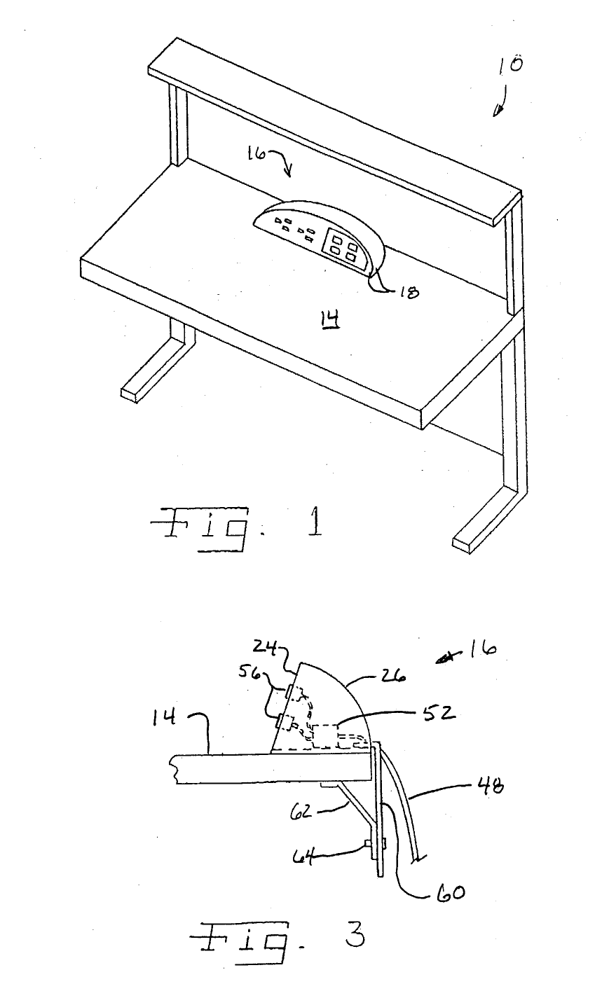

Referring now to the drawings, and more particularly to FIG. 1, there is shown a work center 10 having a support 12 and a worksurface 14. Power/communications module 16 is mounted upon worksurface 14.

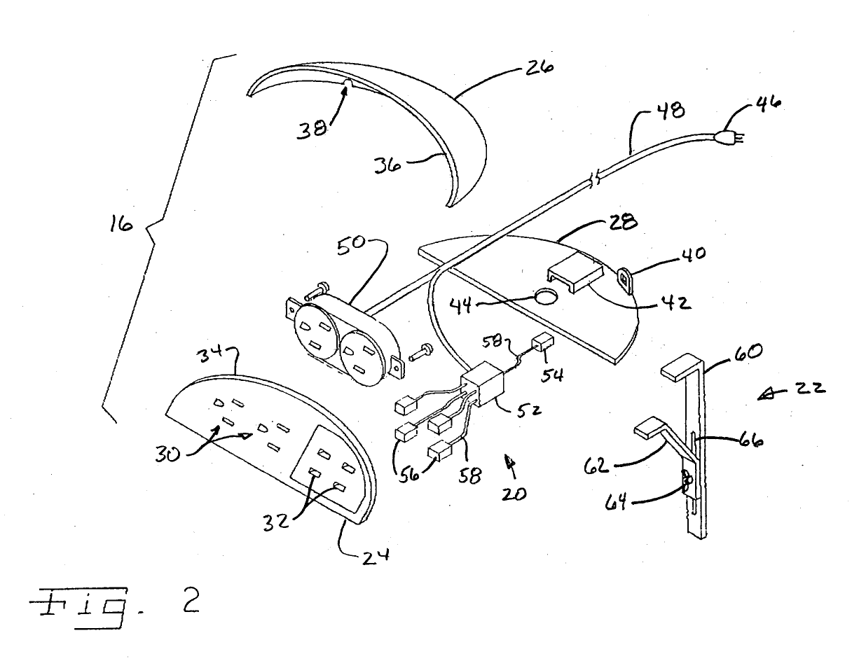

Now, additionally referring to FIGS. 2 and 3, there is shown power/communications module 16 having housing 18, a power/communications assembly 20 and a clamping device 22. Housing 18 includes a face plate 24, a cover 26 and a lower housing 28. Face plate 24, cover 26 and lower housing 28 are snapped together or held together with fasteners.

Face plate 24 includes power distribution openings 30, communication connection openings 32 and contoured surface 34. Power distribution openings 30 accommodate a power receptacle to thereby allow a power plug to be plugged into and through power distribution openings 30 into an electrical receptacle. Communication connection openings 32 are positioned and sized to accommodate communications connectors that may be snapped into place therethrough. Contoured surface 34 is shaped to interface with cover 26.

Cover 26 includes contoured surface 36 and cord notch 38. Contoured surface 36 is shaped to coact with contoured surface 34 to enclose housing 18 and to prevent unintentioned contact with electrical power contained therein. Cord notch 38, in the back of cover 26, allows a power cord to egress from the interior of housing 18.

Lower housing 28 includes communication connection opening 40, a clamp interface 42 and a grommet mount hole 44. Communication connection opening 40 allows a communication connector to be snapped into place for access to a communications cable (not shown). Clamp interface 42 interacts with clamping device 22 to detachably clamp power/communications module 16 to worksurface 14. Grommet mount hole 44 provides for an alternative mounting method of power/communications module 16 to worksurface 14 by way of placing a hole in worksurface 14 and clamping power/communications module 16 thereto, through grommet mount hole 44.

Power/communications assembly 20 includes power plug 46, conductors 48, a duplex receptacle 50, an electronic circuit board 52, an entrance connector 54, interface connectors 56 and conductors 58. Power plug 46 is electrically connected to conductors 48 that provides power to duplex receptacle 50 as well as to electronic circuit 52. Duplex receptacle 50 is fastened to the back side of face plate 24 and aligned such that the power terminals cooperate with power distribution openings 30 to thereby allow a plug to be inserted into power distribution openings 30 and to make electrical contact with duplex outlet 50.

Electronic circuit 52 is connected to a bi-directional data signal and it splits the signal into multiple bi-directional signals. Each of those signals may be further split by other electronic circuits 52. Electronic circuit 52 is in the form of a Universal Serial Bus (USB) hub 52, which is mounted to lower housing 28 and positioned so that conductors 58 can be routed to allow connectors 54 and 56 to be, respectively, snapped into communication connection opening 40 and communication connection openings 32. USB devices, such as keyboards, mice, digital cameras etc., connect to the USB through entrance connectors 54 also known as ports 54. The bi-directional data signals are transferred by way of ports 54 and 56. USB hub 52 functions as a wiring concentrator being able to communicate information from/to multiple devices that are connected by way of corresponding ports 54 through one port 56. Port 56 may connect to a computer or to another USB hub. Each USB hub 52 converts a single attachment port into multiple ports, thereby effectively supporting the concatenation of multiple hubs. Electronic circuit 52 may also be configured to receive a USB connection from a device, such as a computer, and connect to another USB device, such as a printer.

Clamping device 22 includes L-shaped bracket 60, a clamping bracket 62 and fastener 64. L-shaped bracket 60 interacts with clamp interface 42 to connect clamping device 22 to lower housing 28. Clamping bracket 62 is slidably positioned along L-shaped bracket 60 by way of slot 66. Fastener 64 tightens clamping bracket 62 against L-shaped bracket 60 as a surface of clamping bracket 62 contacts a lower surface of worksurface 14.

Power/communications module 16 is mounted to a worksurface 14 of work center 10 by using clamping device 22. Plug 46 is connected to an electrical outlet, thereby providing power to power/communications module 16. A USB cable (not shown) is connected to entrance connector 54 on the back side of power/communications module 16. The other end of the USB cable is connected to a host or personal computer. USB hub 52 provides multiple USB ports on the surface of face plate 24, thereby providing easy access to a user of work center 10 to USB ports. Hub 52 expands the number of connections that are available to thereby allow a user the ability to connect multiple computer peripheral devices to the bus. Power/communications module 16 can be relocated by loosening of clamping device 22 and repositioning of power/communications module 16 on worksurface 14. Alternatively, clamping device 22 may be omitted and power/communications module 16 positioned in any convenient location.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A power and communications assembly, comprising:
a housing removably mountable to a worksurface;
at least one electrical power receptacle at least partially contained in said housing; and
an electronic circuit configured to split one bi-directional signal into a plurality of additional bi-directional signals, said electronic circuit substantially within said housing.

2. The assembly of claim 1, wherein said electronic circuit is an Universal Serial Bus hub.

3. The assembly of claim 2, wherein said Universal Serial Bus hub includes a plurality of interface connections.

4. The assembly of claim 3, wherein said housing includes a face surface having at least one connection receiving opening, at least one of said plurality of interface connections being positioned in said connection receiving opening.

5. The assembly of claim 4, wherein said at least one connection receiving opening is a plurality of connection receiving openings, each of said plurality of connection receiving openings receiving one of a corresponding said plurality of interface connections.

6. The assembly of claim 5, further comprising a clamping mechanism connected to said housing, said clamping mechanism configured to engage a portion of said worksurface.

7. The assembly of claim 6, wherein said housing further comprises an other surface substantially opposite said face surface, said other surface having a connection receiving opening with one of said plurality of interface connections mounted therein.

8. A work center, comprising:
a worksurface; and
a power and communications assembly mounted to said worksurface, said power and communications assembly including:
a housing;
at least one electrical power receptacle partially contained in said housing; and
an electronic circuit configured to split one bi-directional signal into a plurality of additional bi-directional signals, said electronic circuit substantially within said housing.

9. The assembly of claim 8, wherein said electronic circuit is a Universal Serial Bus hub.

10. The assembly of claim 9, wherein said Universal Serial Bus hub includes a plurality of interface connections.

11. The assembly of claim 10, wherein said housing includes a face surface having at least one connection receiving opening, at least one of said plurality of interface connections being positioned in said connection receiving opening.

12. The assembly of claim 11, wherein said at least one connection receiving opening is a plurality of connection receiving openings, each of said plurality of connection receiving openings receiving one of a corresponding said plurality of interface connections.

13. The assembly of claim 12, further comprising a clamping mechanism connected to said housing, said clamping mechanism configured to engage a portion of said worksurface.

14. The assembly of claim 13, wherein said housing further comprises an other surface substantially opposite said face surface, said other surface having a connection receiving opening with one of said plurality of interface connections mounted therein.

15. A method of expanding a bi-directional signal, comprising the steps of:
combining substantially within a housing, a power distribution receptacle and an electronic circuit;
receiving a bi-directional signal by said electronic circuit;
producing at least one other bi-directional signal associated with said bi-directional signal; and
removably affixing said housing to a worksurface.

16. The method of claim 15, wherein said electronic circuit is a Universal Serial Bus hub.

17. The method of claim 16, further comprising the step of positioning a plurality of interface connections on a surface of said housing, said interface connections in communication with said Universal Serial Bus hub.

18. The method of claim 15, further comprising the step of clamping said housing to engage a portion of said worksurface.

19. A power and communications assembly, comprising:
a housing removably mountable to a worksurface;
at least one electrical power receptacle at least partially contained in said housing; and
a circuit configured to receive and redirect a bi-directional signal, said circuit substantially within said housing.
